(19) United States
(12) Patent Application Publication
(10) Pub. No.: US 2011/0290586 A1
(43) Pub. Date: Dec. 1, 2011

(54) Fall Restrict Device

(75) Inventors: Russell A. Goldmann, II, Highland Park, IL (US); Peter A. Grable, Glenview, IL (US); John W. Manser, Elgin, IL (US)

(73) Assignee: KLEIN TOOLS, INC., Lincolnshire, IL (US)

(21) Appl. No.: 12/786,827

(22) Filed: May 25, 2010

(51) Int. Cl. A62B 35/00

(52) U.S. Cl. 182/3

(57) ABSTRACT

A fall restrict device is disclosed. The fall restrict device may include an outer strap having first and second ends, an inner strap having first and second ends, a first releasable connector connected substantially adjacent to the first end of the inner strap, a second releasable connector connected to the second end of the inner strap, and a fastening mechanism releasably secured to the second end of the outer strap for connecting the outer strap to the inner strap. The fastening mechanism includes a carabiner, a link attached to a roller that is moveable along the inner strap, and a plate. The fall restrict device may also include a first adjustment mechanism for adjusting the outer strap and a second adjustment mechanism for adjusting the inner strap. The first adjustment mechanism may comprise a buckle and the second adjustment mechanism may comprise a bracket assembly. The inner strap may comprise a polyamide webbing surrounded by a flexible polymer coating.

### BACKGROUND

1. Field of the Application

The present application relates generally to a fall restrict device, and more particularly to a fall restrict device which may be adjusted during use.

2. Description of the Related Art

In the telecommunications, electrical, and cable TV industries, it is common practice for a field technician (also referred to as a “lineman”) to scale a utility pole. The technician may scale the utility pole to install equipment, to repair broken or damaged communications equipment, to test equipment, and/or for other work-related reasons. To safely and effectively scale a pole and perform line work, the technician utilizes various types of climbing and safety equipment.

Conventional climbing equipment employed by a technician typically includes a pair of pole climbers with gaffs, a body belt, and a pole strap. In general, the gaff is a sharp spike portion protruding at about mid-foot level and having straps that secure the pole climber about the leg and foot of the technician. To climb, the technician drives one of the gaffs into the pole, steps up onto the gaff, and then drives the other gaff into the pole at a higher position. The technician continues to step up the pole in this manner until reaching a desired height.

The body belt is secured around the waist of the technician. The body belt includes loops for carrying tools, and D-rings for attaching the pole strap to the belt. The single pole strap typically includes a snap-hook at each end and a buckle for adjusting its length. During not free-climbing, both hooks of the pole strap are attached to the body belt and the pole strap is passed around the utility pole. Once the desired work location is reached, the technician may adjust the length of the pole strap to a comfortable distance from the pole. Thus, the technician uses the pole strap for climbing as well as supporting the technician in his working position about the pole.

### SUMMARY

A fall restrict device is provided. In one embodiment, the fall restrict device has an outer strap having first and second ends, an inner strap having first and second ends, a first releasable connector connected substantially adjacent to the first end of the inner strap, a second releasable connector connected to the second end of the inner strap, and a fastening mechanism. The fastening mechanism is releasably secured to the second end of the outer strap and connects the outer strap to the inner strap through a link attached to a roller that is moveably connected to the inner strap. The fastening mechanism includes a carabiner and a plate, and the carabiner is secured to the link by the plate.

In another embodiment, the fall restrict device includes an outer strap having first and second ends, an inner strap having first and second ends, a first releasable connector connected substantially adjacent to the first end of the inner strap, a second releasable connector connected to the second end of the inner strap, a first adjustment mechanism attached to the outer strap, a fastening mechanism releasably connecting the inner strap and the second end of the outer strap and including a roller that is moveably connected to the inner strap, and a second adjustment mechanism including a bracket having a first fastener for connecting the inner strap with a portion of the outer strap substantially adjacent the first end of the outer strap, the bracket including a pathway therethrough for the inner strap and a cam paddle for adjusting the inner strap, the cam paddle being disposed to rotate toward and away from the pathway.

In yet another embodiment, the fall restrict device includes an inner strap comprising a polyamide webbing and a flexible polymer coating surrounding the polyamide webbing, the inner strap having first and second ends, a first releasable connector connected substantially adjacent to the first end of the inner strap, a second releasable connector connected to the second end of the inner strap, an outer strap having a first end connected substantially adjacent to the first end of the inner strap and a second end connected substantially adjacent to the second end of the inner strap, and a fastening mechanism releasably secured to the second end of the outer strap for connecting the outer strap to the inner strap, the fastening mechanism comprising a carabiner, a link attached to a roller, and a plate. The carabiner is secured to the roller by the plate and a fastener.

These as well as other aspects will become apparent to those of ordinary skill in the art by reading the following detailed description, with reference where appropriate to the accompanying drawings. Further, it should be understood that the embodiments described in this summary and elsewhere are intended to illustrate examples of the present application.

### BRIEF DESCRIPTION OF THE DRAWINGS

Exemplary embodiments of the application are described herein with reference to the drawings, in which:

FIG. 1 illustrates a perspective view of an example fall restrict device of the present application;

FIG. 1a illustrates an alternative example adjustment mechanism that may be used with the fall restrict device shown in FIG. 1;

FIG. 2 illustrates a top view of a first end of an example outer strap used with the fall restrict device of shown in FIG. 1;

FIG. 3 illustrates a side view of an example fastening mechanism for use with the fall restrict device shown in FIG. 1;

FIG. 4 illustrates a top view of the fastening mechanism shown in FIG. 3;

FIG. 5 illustrates a side view of an alternate example embodiment of a fastening mechanism for use with the fall restrict device shown in FIG. 1;

FIG. 6 illustrates a the fastening mechanism shown in FIG. 5 attached to the fall restrict device shown in FIG. 1;

FIG. 7 illustrates a top view of an example bracket assembly for use with the fall restrict device shown in FIG. 1;

FIG. 8 illustrates a side view of the bracket assembly shown in FIG. 7;

FIG. 9 illustrates an end view of the bracket assembly shown in FIG. 7;

FIG. 10 illustrates a cross-sectional view of an example inner strap for use with the fall restrict device shown in FIG. 1;

FIG. 11 illustrates a side view of the fall restrict device shown in FIG. 1 in use; and

FIG. 12 illustrates a top view of the fall restrict device shown in FIG. 1.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present application is directed to a fall restrict device that may be attached to a body belt and used for working upon, ascending, and descending a pole, such as a wood pole, for example. Alternatively, the fall restrict device may be used with poles made of other materials, such as composite, fiberglass, concrete, etc. The fall restrict device may include an outer strap and an inner strap. Both the outer and inner straps are adjustable. In one example, two adjustments may be performed to place the fall restrict device in a desired orientation for a user—one adjustment to the outer strap and one adjustment to the inner strap. The inner strap may further include a coating to increase flexibility and durability of the inner strap.

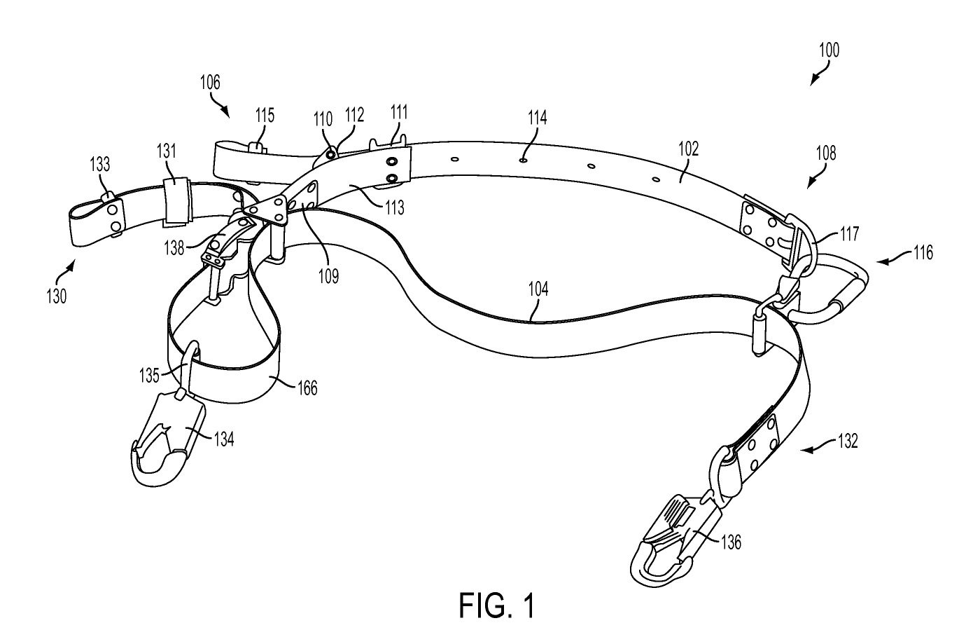

Referring now to the Figures, FIG. 1 illustrates an example fall restrict device 100. The fall restrict device 100 may include an outer strap 102 and an inner strap 104. The outer strap 102 may have a first end 106 and a second end 108. The first end 106 of the outer strap 102 may include a first adjustment mechanism 110 to allow the outer strap 102 to be adjustable to different lengths. Thus, the fall restrict device 100 may accommodate a variety of poles having different diameters. In one arrangement, the outer strap 102 may accommodate poles with diameters in a range of about 8 inches to about 16 inches. The first adjustment mechanism 110 may be a tongue buckle, for example, and allow the outer strap 102 to be adjusted while a technician is either on the ground or during use. The first adjustment mechanism 110 may have a tongue 112 that fastens to corresponding holes 114 which are spaced apart along the outer strap 102. Alternatively, any suitable adjustment mechanism may be used to adjust the outer strap 102, such as a friction slide adjuster, slide buckle, or cam paddle, for example. An example of a friction slide adjuster is shown in FIG. 1a.

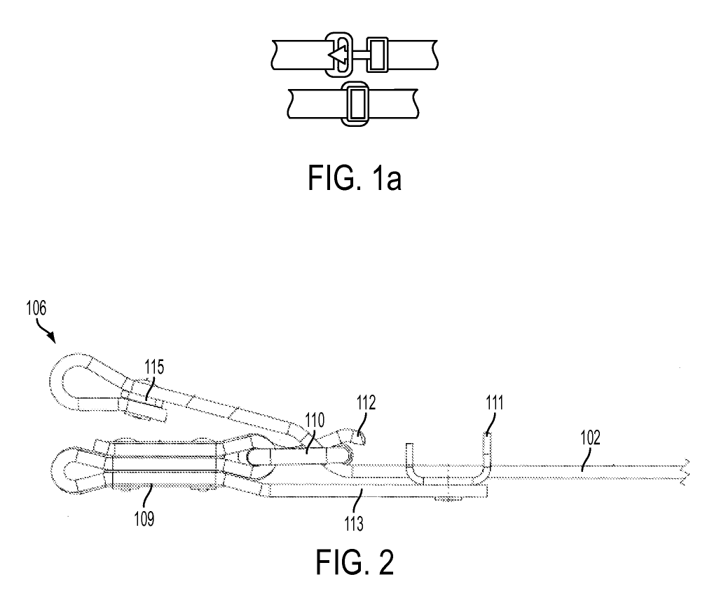

Referring now to FIG. 2, a top view of the first end 106 of the outer strap 102 is shown. The outer strap 102 may further include a guide bracket 111. The guide bracket 111 may maintain the outer strap 102 in the desired position when placed around a pole. Although the guide bracket 111 is shown near the first end 106 of the outer strap, it should be understood that the guide bracket 111 may be located at any position along the outer strap 102. The outer strap 102 may also include a folded portion 113 which connects to the back of the guide bracket 111. The folded portion 113 provides rigidity to the outer strap 102. The folded portion 113 may include a reinforcing plate 109, which may be a metal reinforcement plate, for example. The reinforcing plate 109 may abut against the pole when the fall restrict device 100 is in use, as shown in FIG. 12. In one embodiment, the reinforcing plate 109 may include cleats or similar gripping elements to increase the gripping strength of the reinforcing plate 109, such as on slippery or icy poles, for example.

Referring back to FIG. 1, the outer strap 102 may also include a stopping mechanism 115 located near the first end 106. The stopping mechanism 115 may be a metal stopping mechanism, for example, such as a metal plate. The stopping mechanism 115 provides for maximum length adjustment of the outer strap 102, and also prevents the outer strap 102 from sliding completely through the first adjustment mechanism 110.

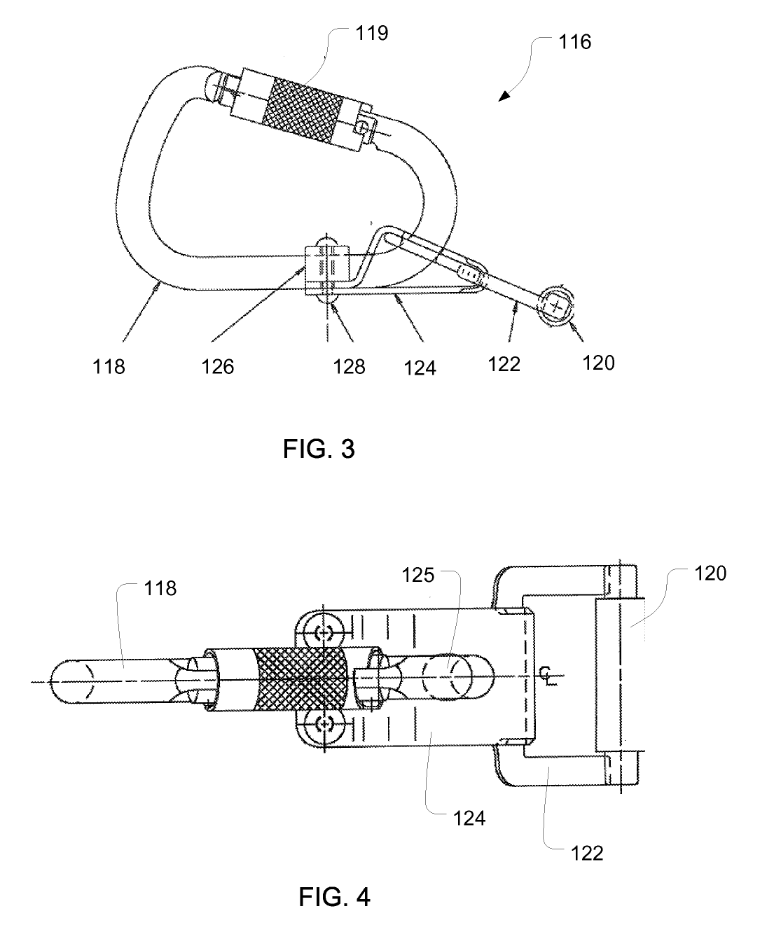

The second end 108 of the outer strap 102 may include a D-ring 117 which may attach to a fastening mechanism 116 to secure the second end 108 of the outer strap 102 to the inner strap 104. The fastening mechanism 116 may include a carabiner assembly, for example, which is shown in detail in FIGS. 3 and 4.

In FIGS. 3 and 4, a side view and a top view of an example fastening mechanism 116 is provided. The fastening mechanism 116 may include a carabiner 118 that is attached to the D-ring 117 on one side and connected through a link 122 to a roller 120 on the other side. The fastening mechanism 116 can move freely along the inner strap 104 at roller 120. In an alternate embodiment, the roller can move along the outer strap 102 and the D-ring 117 may be attached to the inner strap 104.

The carabiner 118 may be releasably secured to the outer strap 102. For example, the carabiner 118 may include a spring catch 119 on one side, which facilitates connection and disconnection of the carabiner 118 to the outer strap 102 by a user. The spring catch 119 may include either a single, double, or triple locking mechanism, for example. Alternatively, any suitable fastener may be substituted for the carabiner 118, such as a single or double locking snap hook.

The roller 120 may be attached to the link 122 which may be secured to the carabiner 118 by a plate 124. The plate 124 may be secured to the carabiner 118 by a block 126 and one or more fasteners 128, such as a rivet, for example. The link 122 may be secured to the plate 124 and carabiner 118 in a manner so as to allow a small freedom of movement. In this way, such an attachment may lesson a strain on the metallurgy of the carabiner 118, link 122, and the plate 124 by avoiding use of a weld. To provide the small freedom of movement, the link 122 may include a hole 125 through which the carabiner 118 is inserted, and the hole 125 may be of a circumference slightly larger than the portion of the carabiner 118 positioned through the hole 125.

Further, due to a shape and configuration of the plate 124 (as shown in FIGS. 3-4), the plate 124 will not allow the link 122 to move more than within a small margin of space since one end of the link 122 also connects to the carabiner 118. Using the link 122 and plate 124 with the fastening mechanism 116 may strengthen a connection between the roller 120 and the carabiner 118, for example. Other connections are possible as well.

Alternatively, the plate 124 may be secured to the carabiner 118 by the block 126 in a secured fashion so as not to allow any movement between or among the plate 124 and the block 126. Similarly, in one example, the link 122 may be secured to the plate 124 in a manner that also provides a fixed attachment, such as a weld.

The plate 124 also maintains an angle of about 90° between the carabiner 118 and the link 122 and allows the fall restrict device 100 to lay flat against a pole. The plate 124 also presents the carabiner 118 to the user as a handle, which allows the user to grasp the fastening mechanism 116 with one hand, which facilitates movement of the user when the device 100 is in use. The plate 124 abuts the pole during use, as shown in FIG. 12. In one embodiment, the plate 124 may include cleats or similar gripping elements to increase the gripping strength of the plate 124, such as on slippery or icy poles, for example.

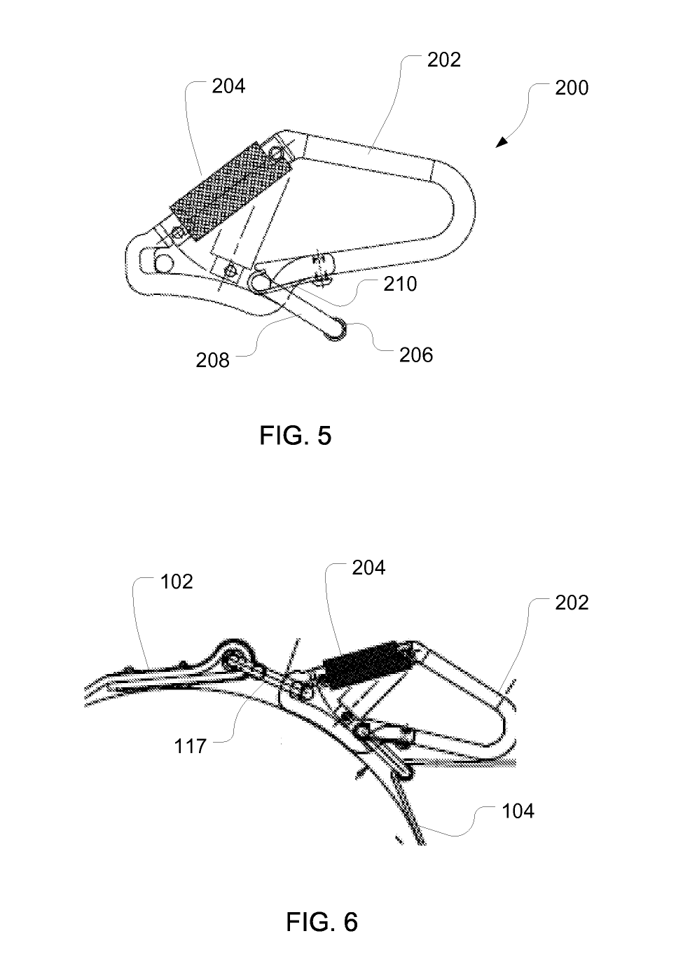

FIGS. 5 and 6 show an alternate embodiment of a fastening mechanism 200 that can be used with the fall restrict device 100. The fastening mechanism 200 may include a carabiner 202 that is attached to the D-ring 117 on one side and connected through a link 208 to a roller 206 on the other side. The fastening mechanism 200 can move freely along the inner strap 104 at roller 206. In an alternate embodiment, the roller can move along the outer strap 102 and the D-ring 117 may be attached to the inner strap 104. The carabiner 202 may be releasably secured to the outer strap 102. For example, the carabiner 202 may include a spring catch 204 on one side, which facilitates connection and disconnection of the carabiner 202 to the outer strap 102 by a user. The spring catch 204 may include either a single, double, or triple locking mechanism, for example. Alternatively, any suitable fastener may be substituted for the carabiner 202, such as a single or double locking snap hook.

The roller 206 may be attached to the link 208 which may be secured to the carabiner 202 by a plate 210. The link 208 may be secured to the plate 210 and carabiner 202 in a manner so as to allow a small freedom of movement. In this way, such an attachment may lesson a strain on the metallurgy of the carabiner 202, link 208, and the plate 210 by avoiding use of a weld. Alternatively, the plate 210 and link 208 may be welded to the carabiner 202.

Referring back to FIG. 1, the outer strap 102 comprises a strong and durable material, such as Klein-Kord®, which is made of neoprene impregnated rubber that has been vulcanized, for example. The material of the outer strap 102 may further include a wear indicator to indicate to a user that the strap should be removed from service. Examples of the material and wear indicator feature are further described in U.S. Pat. No. 2,152,943, which is incorporated by reference herein in its entirety. Alternatively, the outer strap 102 may comprise other durable materials, such as reinforced webbing, for example.

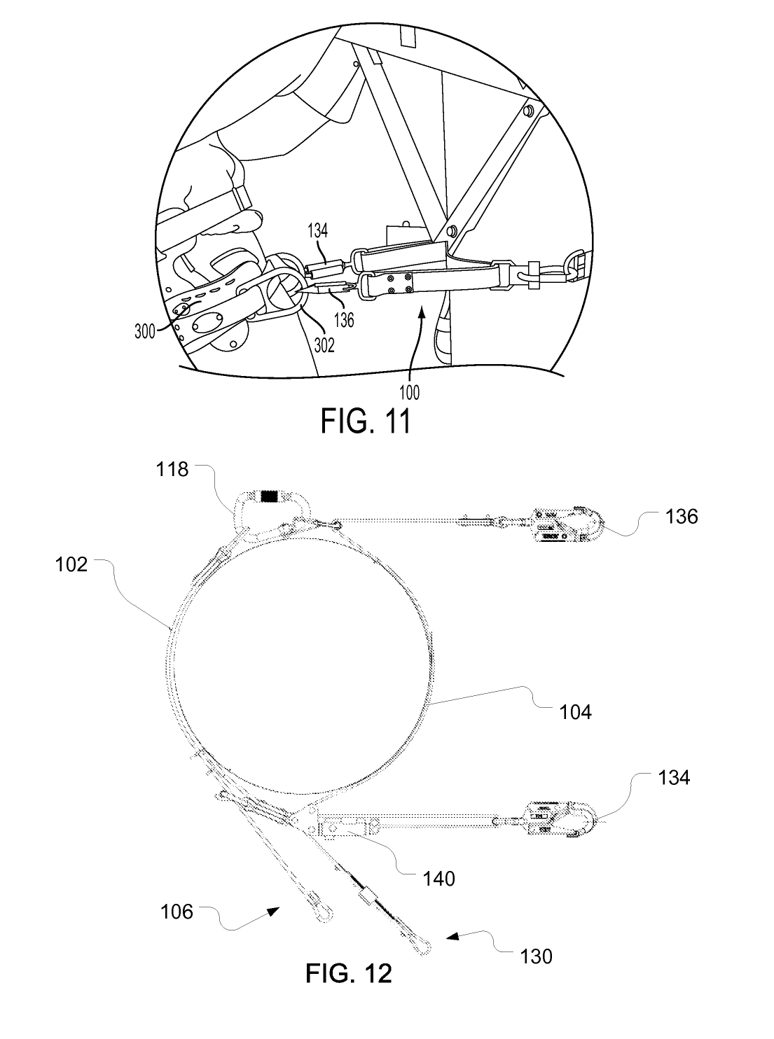

The inner strap 104 may also include a first end 130 and a second end 132. A first releasable connector 134, such as a snap-hook connector, for example, may be located near the first end 130 of the inner strap 104. The first releasable connector 134 may attach to a body belt 300 (shown in FIG. 11), and may be locked into place by the user. The first releasable connector 134 may be secured to the inner strap 104 by a roller 135 which allows the first releasable connector 134 to move along the inner strap 104. The second end 132 of the inner strap 104 may include a second releasable connector 136, such as a second snap-hook connector, for example. The second releasable connector 136 may also attach to the body belt 300 for additional support. The second releasable connector 136 may be fixedly secured to the second end 132 of the inner strap 104 so that the second releasable connector 136 cannot move along the inner strap 104. This provides more stability to the user and also maintains the second releasable connector 136 in the proper position. The user can reposition himself around the pole when the first releasable connector 134 and the second releasable connector 136 are secured to the body belt.

The inner strap 104 may further include a retaining strap 131 near the first end 130. The retaining strap 131 may be used to retain the free first end 130 of the inner strap 104 to prevent the inner strap 104 from interfering with the technician during use. The retaining strap 131 may be made of Velcro® or any other suitable fastening mechanism. The inner strap 104 may also include a stopping mechanism 133 located near the first end 130. The stopping mechanism 133 may be a metal stopping mechanism, for example, such as a metal plate. The stopping mechanism 133 provides for maximum length adjustment of the inner strap 104, and also prevents the inner strap 104 from sliding completely through a second adjustment mechanism 138, which is described below.

The first end 130 of the inner strap 104 may be moveably connected to the outer strap 102 by a second adjustment mechanism 138. The second adjustment mechanism 138 may be located substantially adjacent to the first end 130 of the inner strap 104, or alternatively may be located closer to the second end 132 of the inner strap 104. The second adjustment mechanism 138 may include a bracket assembly, for example. However, it should be understood that any suitable adjustment mechanism may be used, such as a buckle or a friction slide adjuster, for example. The second adjustment mechanism 138 enables the inner strap 104 to be adjusted when in use to provide for a desired positioning of the user about the pole.

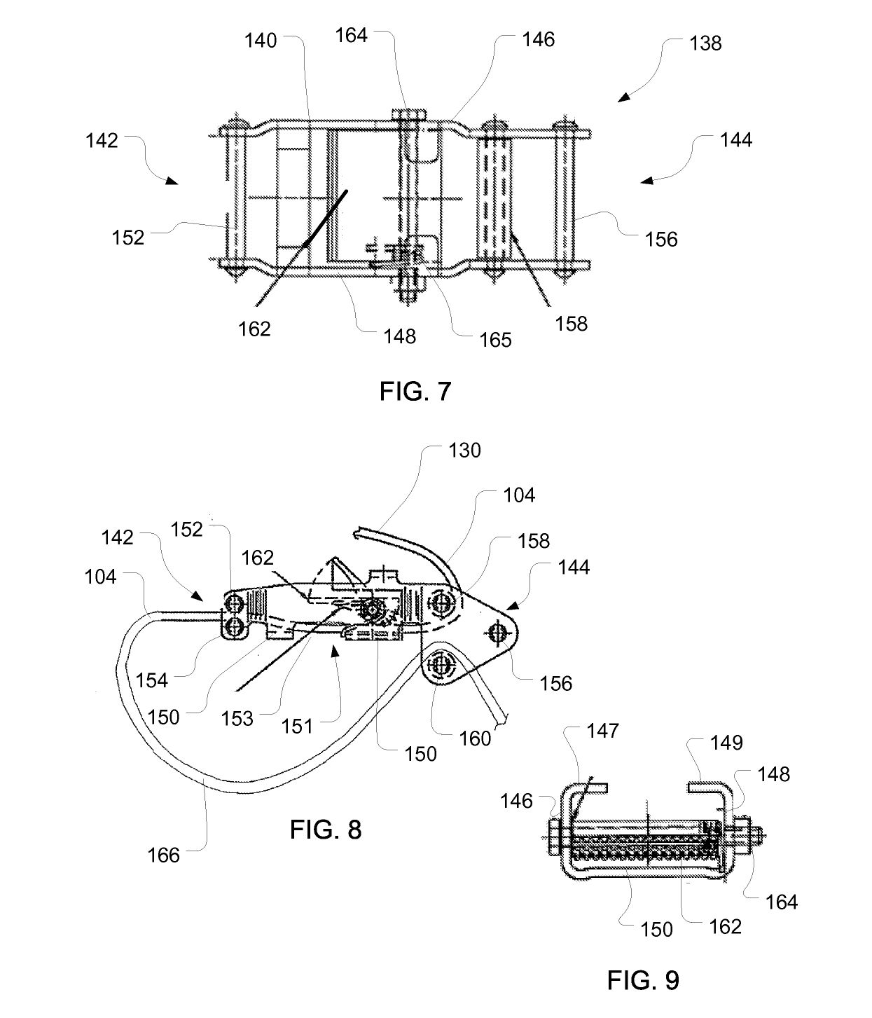

Referring now to FIGS. 7-9, which show a top view, side view, and end view of the second adjustment mechanism 138, the second adjustment mechanism 138 may include an adjusting bracket 140. The bracket 140 may have a locking mechanism, such as a cam paddle 162. In other embodiments, the locking mechanism may comprise a buckle or a friction slide adjuster, for example. The bracket 140 may have a first end 142 and a second end 144. The bracket 140 may further include a first sidewall 146, a second sidewall 148, and a bottom wall 150, the three of which create a pathway 151 for surrounding and supporting the inner strap 104. The bottom wall 150 may be continuous or may be divided into a plurality of sections separated by slots 153. The first sidewall 146 may include a first tab 147 and the second sidewall 148 may include a second tab 149 extending inwardly toward the center of the bracket 140. The first and second tabs 147, 149 prevent the cam paddle 162 from over-rotating during use. The first end 142 of the bracket 140 may include a plurality of rivets 152, 154 for grasping and guiding the inner strap 104 through the pathway 151. It should be understood that the rivets 152, 154 may be replaced by any suitable fastener, such as bolts or pins, for example.

The second end 144 of the bracket 140 may be secured substantially adjacent to the first end 106 of the outer strap 102 by a fastener 156. The fastener 156 is shown as a rivet, but it should be understood that any suitable fastener may be used to secure the bracket 140 to the outer strap 102. The second end 144 of the bracket 140 may further include first and second rollers 158, 160 for guiding the inner strap 104 through the pathway 151. The inner strap 104 may move freely between the second roller 160 and the roller 120, as shown in FIG. 12. The bracket 140 may further include a cam paddle 162 which may be secured to the sidewalls 146, 148 of the bracket 140 by a fastener 164. The cam paddle 162 allows a length of the inner strap 104 between the first end 130 of the inner strap 104 and the bracket 140 to be changed, to either loosen or tighten the inner strap 104. A spring 165 located on the fastener 164 actuates the cam paddle 162 to rotate toward and away from the pathway 151.

As shown in FIG. 8, which is a side view of the second adjustment mechanism 138, the inner strap 104 is placed within the pathway of the bracket 140 so the first end 130 of the inner strap 104 extends outwardly from the second end 144 of the bracket 140. The inner strap 104 further extends between rollers 158 and 160, under the cam paddle 162, and between the rivets 152, 154. The inner strap 104 then creates a loop 166 and is fed back under the bottom wall 150 of the bracket 140, between rollers 158 and 160, and under the fastener 156. The first releasable connector 134 may be attached to the inner strap 104 within the loop 166, as shown in FIG. 1.

Thus, referring briefly back to FIG. 1, the loop 166 provides additional length of material of the inner strap 104 that may be used with rollers 135, 160, and 120 to adjust a portion of the inner strap 104 between the first end 130 and the second releasable connector 136 to a desired orientation. Further, by providing additional length of the inner strap 104 in the loop 166 configuration in combination with rollers 135, 160, and 120 enables one integral piece of material to be used for the inner strap 104. The one integral piece of material can be adjusted by a technician without exchanging or integrating additional straps, for example. The inner strap 104 may be of a length to enable the inner strap 104 to adjust both to the user and to the pole diameter.

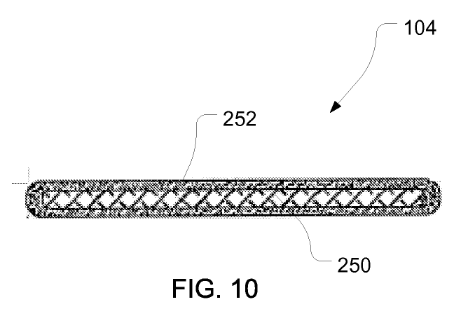

Referring now to FIG. 10, the inner strap 104 may be constructed of an inner layer 250 and a flexible external coating 252. The inner layer 250 may be a polyamide webbing, such as nylon or polyester webbing, for example. The inner strap 104 may further include a flexible external coating 252 coextruded over the inner layer 250, which may be a material that resists abrasion, such as a thermoplastic urethane (TPU), polyvinyl chloride (PVC), or a silicone polymer, for example. The coating 252 may be resistant to certain chemicals and flexible, with an elongation of about 400%, for example. The coating 252 may also enable the inner strap 104 to be used within a temperature range, such as from about −40° C. to well over 100° C., and the coating 252 may provide flame resistivity and dielectric properties. The coating 252 increases the flexibility and abrasion of the inner strap 104. The inner strap 104 may further include a red wear indicator located between the inner layer 250 and coating 252 (not shown) made of cord fabric, such as the wear indicator described in U.S. Pat. No. 2,152,943, to indicate to a user when the inner strap 104 should be removed from service, for example.

FIGS. 11 and 12 show the fall restrict device 100 in use. In operation, the technician first connects the first and second releasable connectors 134, 136 to D-rings 302 on his body belt 300. Then, when the technician is ready to ascend a pole, a right-handed user places the fall restrict device 100 so that the bracket assembly 140 is at the 9o'clock position and the fastening mechanism 116 is at the 3 o'clock position. A left-handed user would place the bracket assembly 140 at about the 3 o'clock position and the fastening mechanism 116 at about the 9 o'clock position. The technician then disconnects the fastening mechanism 116 from the outer strap 102 and adjusts the first adjustment mechanism 110 on the outer strap 102 to accommodate the pole diameter. For larger poles, the second adjustment mechanism 138 on the inner strap 104 may also need to be adjusted. The fall restrict device 100 may then be placed around the pole and the fastening mechanism 116 is reconnected to the outer strap 102. The outer and inner straps 102, 104 of the fall restrict device 100 should lie flat against the pole. After checking that all fastening mechanisms and connectors are completely closed, the technician leans backward and places his full body weight on fall restrict device 100. The plate 124 of the fastening mechanism 116 abuts the pole on one side, and the reinforcing plate 109 abuts the pole on the other side. In the case of a slip or fall, both the plate 124 and reinforcing plate 109 tighten against the pole, which causes the inner strap 104 and the outer strap 102 to remain fixed against the pole, thereby preventing the technician from falling to the ground.

The technician may then ascend the pole to the desired position. Once he has reached the desired position, the technician may adjust the inner strap 104 of the fall restrict device 100 using the second adjustment mechanism 138 to adjust his position about the pole and securely tighten the fall restrict device 100. For example, to increase working distance, or move farther away from the pole, the technician may depress the cam paddle 162 to release additional length of the inner strap 104. The technician may then release the cam paddle 162 when the desired position is reached. The cam paddle 162 then locks in place. The weight of the technician pulls substantially equally on both sides of the inner strap 104 to tend to keep the technician safely centered about the pole.

Similarly, to decrease working distance, or move closer to the pole, the technician may grasp the second adjustment mechanism 138 with one hand and pull the free end, first end 130, of the inner strap 104 toward himself with the other hand. The technician may or may not depress the cam paddle 162 before pulling on the inner strap 104. When the desired position is reached, the cam paddle 162 locks into place. The weight of the technician pulls substantially equally on both sides of the inner strap 104 to tend to keep the technician safely centered about the pole.

When the technician is ready to descend the pole, he may loosen the inner strap 104 slightly. The technician then climbs down by pulling outwardly on the second adjustment mechanism 138 and the fastening mechanism 116 and sliding the fall restrict device 100 down the pole. When the technician reaches the ground, he may then loosen the outer strap 102 from the pole, and disconnect the fastening mechanism 116 from the outer strap 102 to remove the fall restrict device 100 from the pole.

Although the second adjustment mechanism 138 is shown on a left of the fall restrict device 100 (when in use) and the fastening mechanism 116 is shown on a right of the fall restrict device 100 (when in use), a configuration of the fall restrict device 100 may be provided in an opposite manner so as to provide the second adjustment mechanism 138 on the right and the fastening mechanism 116 on the left, for example.

The fall restrict device 100 may be used with a secondary positioning device, such as an adjustable positioning lanyard (APL) to provide additional security for the technician when climbing past an obstruction.

Various example embodiments have been described. The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. Further, many of the elements that are described are functional entities that may be implemented as discrete or distributed components or in conjunction with other components, in any suitable combination and location.

1. A fall restrict device comprising:
an outer strap having first and second ends;
an inner strap having first and second ends;
a first releasable connector connected substantially adjacent to the first end of the inner strap;
a second releasable connector connected to the second end of the inner strap;
a fastening mechanism releasably secured to the second end of the outer strap and connecting the outer strap to the inner strap through a link attached to a roller that is moveably connected to the inner strap, wherein the fastening mechanism comprises a carabiner and a plate, wherein the carabiner is secured to the link by the plate.

2. The fall restrict device of claim 1 further comprising a first adjustment mechanism attached to the outer strap, wherein the first adjustment mechanism includes a buckle.

3. The fall restrict device of claim 1 further comprising a second adjustment mechanism attached to the inner strap, wherein the second adjustment mechanism comprises a bracket assembly including a bracket having a first fastener for connecting a portion of inner strap substantially adjacent the first end of the inner strap with a portion of the outer strap substantially adjacent the first end of the outer strap, the bracket including a pathway therethrough for the inner strap and a cam paddle for adjusting a length of the inner strap between the bracket and the second end of the inner strap, the cam paddle being disposed to rotate toward and away from the pathway.

4. The fall restrict device of claim 3 wherein the fastening mechanism is located between the second end of the inner strap and the second adjustment mechanism.

5. The fall restrict device of claim 3 wherein the cam paddle is secured to the bracket by a second fastener, wherein the second fastener allows a length of the inner strap between the first end of the inner strap and the bracket to be changed, and wherein the cam paddle is used to free the inner strap.

6. The fall restrict device of claim 3 wherein the bracket further comprises:
a plurality of rivets for grasping and guiding the inner strap through the pathway; and
first and second rollers for guiding the inner strap through the pathway.

7. The fall restrict device of claim 6 wherein the inner strap is placed within the pathway of the bracket so the first end of the inner strap extends outwardly from one end of the bracket, and the inner strap extends under a bottom of the bracket and through the fastener to create a loop.

8. The fall restrict device of claim 7 wherein the first releasable connector is attached to the inner strap within the loop.

9. The fall restrict device of claim 1 wherein the link has a hole through which the carabiner is inserted, the hole having a circumference larger than a portion of the carabiner positioned through the hole.

10. The fall restrict device of claim 1 wherein the inner strap comprises a polyamide webbing and a flexible polymer coating surrounding the polyamide webbing.

11. A fall restrict device comprising:
an outer strap having first and second ends;
an inner strap having first and second ends;
a first releasable connector connected substantially adjacent to the first end of the inner strap;
a second releasable connector connected to the second end of the inner strap;
a first adjustment mechanism attached to the outer strap;
a fastening mechanism releasably connecting the inner strap and the second end of the outer strap, the fastening mechanism including a roller that is moveably connected to the inner strap; and
a second adjustment mechanism including a bracket having a first fastener for connecting the inner strap with a portion of the outer strap substantially adjacent the first end of the outer strap, the bracket including a pathway therethrough for the inner strap and a cam paddle for adjusting the inner strap, the cam paddle being disposed to rotate toward and away from the pathway.

12. The fall restrict device of claim 11 wherein the cam paddle is secured to the bracket by a second fastener, wherein the second fastener allows a length of the inner strap between the first end of the inner strap and the bracket to be changed, and wherein the adjustment paddle is used to free the inner strap.

13. The fall restrict device of claim 11 wherein the bracket further includes:
a plurality of rivets for grasping and guiding the inner strap through the pathway; and
first and second rollers for guiding the inner strap through the pathway.

14. The fall restrict device of claim 13 wherein the inner strap is placed within the pathway of the bracket so the first end of the inner strap extends outwardly from one end of the bracket, and the inner strap extends under a bottom of the bracket and through the first fastener to create a loop.

15. The fall restrict device of claim 14 wherein the first releasable connector is attached to the inner strap within the loop.

16. The fall restrict device of claim 11 wherein the link has a hole through which the carabiner is inserted, the hole having a circumference larger than a portion of the carabiner positioned through the hole.

17. The fall restrict device of claim 11 wherein the first adjustment mechanism is located at the first end of the outer strap and the second adjustment mechanism is located at the first end of the inner strap.

18. The fall restrict device of claim 11 wherein the inner strap comprises a polyamide webbing and a flexible polymer coating surrounding the polyamide webbing.

19. A fall restrict device comprising:
an inner strap comprising a polyamide webbing and a flexible polymer coating surrounding the polyamide webbing, the inner strap having first and second ends;
a first releasable connector connected substantially adjacent to the first end of the inner strap;
a second releasable connector connected to the second end of the inner strap;
an outer strap having a first end connected substantially adjacent to the first end of the inner strap and a second end connected substantially adjacent to the second end of the inner strap;
a fastening mechanism releasably secured to the second end of the outer strap for connecting the outer strap to the inner strap, the fastening mechanism comprising a carabiner, a link attached to a roller, and a plate, wherein the carabiner is secured to the roller by the plate and a fastener.

20. The fall restrict device of claim 19 wherein the flexible polymer coating comprises a thermoplastic urethane coating.

21. The fall restrict device of claim 19 further comprising a first adjustment mechanism attached to the outer strap, the first adjustment mechanism including a buckle.

22. The fall restrict device of claim 19 further comprising a second adjustment mechanism attached to the inner strap, the second adjustment mechanism including a bracket assembly.
